(19) United States
(12) Patent Application Publication
(10) Pub. No.: US 2008/0181368 A1
(43) Pub. Date: Jul. 31, 2008

(54) SYSTEM DIAGNOSTICS

(76) Inventors: Mark O'Sullivan, Northall (GB); Graham Streit, London (GB); Mario Zancan, Mttgham (GB)

Correspondence Address: MG-IP Law, PLLC, PO BOX 1364, FAIRFAX, VA, 22038-1364, US

(21) Appl. No.: 11/864,336

(22) Filed: Sep. 28, 2007

(30) Foreign Application Priority Data
Sep. 29, 2006 (GB) 0619270.2

(51) Int. Cl. H04M 1/24

(52) U.S. Cl. 379/1.01

(57) ABSTRACT

A method of providing diagnostic functionality in a SIP enabled telephony system includes a plurality of SIP enabled functional elements each provided with a diagnostics agent, the method including transmitting a SIP diagnostics request from an originator diagnostics agent of a first element to a diagnostics agent of a second element.

### CROSS-REFERENCE TO RELATED APPLICATIONS

This application claims the benefit under 35 U.S.C. § 119 of Great Britain Patent Application No. 0619270.2, entitled SYSTEM DIAGNOSTICS which was filed on Sep. 29, 2006, the entirety of which is incorporated by reference herein.

### BACKGROUND

1. Field of the Invention

The present invention relates to systems in which trunks are established for private exchanges using Internet telephony service providers.

2. Description of the Related Art

Internet telephony services allow for the provision of telephony services at reduced costs. For enterprises (such as companies) where there is a large number of users of telephone systems the cost savings can be significant.

The provision of Internet telephony services for a PBX environment can be complex. The initial configuration can be complex, and updating to take account of changes can be complex. This complexity provides opportunities for many things to go wrong, and the complexity means that identifying errors and addressing them is not trivial.

It is an aim of the invention to provide an improved technique which addresses one or more of the above identified problems.

### SUMMARY

In accordance with the invention there is provided a method of providing diagnostic functionality in a SIP enabled telephony system comprising a plurality of SIP enabled functional elements each provided with a diagnostics agent, the method comprising the steps of: transmitting a SIP diagnostics request from an originator diagnostics agent of a first element to a diagnostics agent of a second element.

The method further comprises the step of transmitting the request from the second diagnostics agent to a third diagnostics agent.

The method further comprises the step of transmitting a diagnostics request to successive diagnostic agents.

A diagnostics agent associated with a functional element may forward a diagnostic request to another diagnostics agent of another functional element on determination of that another functional element being associated with a session or attempted session with which the diagnostics request is concerned.

Each diagnostics agent may return a reply to the diagnostics agent from which it received a request. A reply from each diagnostics agent receiving a diagnostics request may be transmitted to the originating diagnostics agent.

The SIP enabled functional elements may include any one of: a private branch exchange, an Internet service telephony provider, or a telephone handset.

Further in accordance with the invention there is provided a SIP enabled telephony element including a diagnostics agent, and adapted to generate a diagnostics request for transmission to a diagnostics agent of a further SIP enabled telephony element.

The SIP enabled telephony system may be further adapted to generate the diagnostics request responsive to an error condition being met. The error condition may be a predetermined event at the SIP enabled telephony element.

The SIP enabled telephony element may be further adapted to generate the diagnostics request responsive to a diagnostics request being received from a further diagnostics agent.

A diagnostics agent of a functional element may be adapted to determine a functional element associated with the diagnostic request, and transmit the diagnostic request to a diagnostics agent of that functional element.

The determination of the functional element associated with the diagnostic request includes identifying a functional element associated with a session.

The diagnostics request may be intended to diagnose a feature of the session.

### BRIEF DESCRIPTION OF THE FIGURES

FIG. 1 illustrates a PBX environment in which embodiments of the invention may be implemented; and

FIG. 2 illustrates a signalling exchange in accordance with an embodiment of the invention.

### DESCRIPTION OF PREFERRED EMBODIMENTS

The invention is now described with reference to various embodiments. It should be understood that the invention is not limited to specific aspects of any one embodiment.

The embodiments of the invention may be implemented in an environment where an enterprise, such as a company, having a PBX (private branch exchange) system or systems intends to take advantage of the services provided by an ITSP (Internet telephony service provider). An ITSP offers an Internet data service for making telephone calls using VoIP (Voice over IP) technology. Typically ITSPs use SIP (session initiation protocol) for transmitting telephone calls as IP data packets. The advantages of using an ITSP for an enterprise include cost savings and increased functionality.

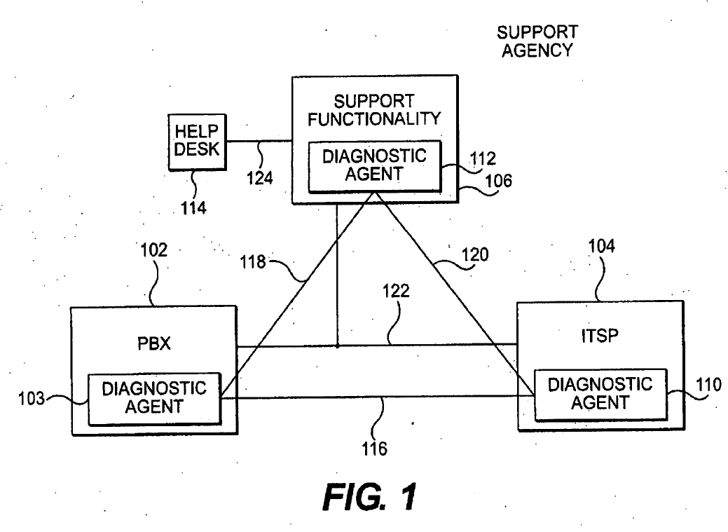

An example environment in which embodiments of the present invention may be implemented is illustrated schematically in FIG. 1. An enterprise or company PBX 102 is provided with a diagnostic agent 108. An ITSP 104 is provided with a diagnostics agent 110. A support agency including support functionality 106 is provided with a diagnostic agent 112. The support functionality is connected to a help desk 114 via a connection 124. Each of the diagnostic agents 108, 110, and 112 may be interconnected: in practice in preferred embodiments the diagnostic agents are connected on demand using SIP signalling. For the purposes of illustration FIG. 1 shows connections between the diagnostic agents. Connection 118 connects diagnostic agents 108 and 112; connection 120 connects diagnostic agents 110 and 112; and connection 116 connects diagnostic agents 108 and 110. The PBX 102, ITSP 104 and support functionality 106 are interconnected via communication link 122. All of the interconnections shown in FIG. 1 may be provided by the Internet or other suitable data networks.

Each of the diagnostic agents 108, 110, and 112 is preferably an application running on the associated system (PBX 102, ITSP 104, or support functionality 106). Preferably each diagnostics agent is a session initiation protocol (SIP) user agent (UA). Each diagnostics agent can preferably respond to incoming sessions from support personnel or other diagnostics agents in the network.

In general, in response to issues detected or requests to resolve issues, each agent can: exchange trace information with other agents (automated or support personnel driven); report on domain name issues; report on DTMF (dual-tone multi-frequency) recognition issues; report voice quality feedback; report missing numbers; report types of service; obtain error logs; and obtain system configuration information.

The diagnostics agents can also execute scripts to ran internal automated test scenarios; delegate or become master to coordinate agent activities; and gather additional trace and support information, before submissions of combined results. The help desk may issue and exchange references to enable correlation between active parties. The diagnostic agents may: enable system configuration changes, as script or interactive; initiate sessions at source to enable testing; utilise policy to control access and scope of support features exposed; and leverage the SIP infrastructure (where used) to enable rich session and media/payload faculties.

Referring to the example scenario of FIG. 1, a service agent associated with the help desk 114 may interact with any diagnostics agent to test and diagnose issues, and to gather information.

Any issues detected by a diagnostics agent can be followed up by coordinating diagnostics gathering from other agents in the network, customer or ITSP. The support agency can then be presented with end-to-end diagnostics information about the issue.

A diagnostics agent associated with a particular functional element, such as the diagnostics agent 108 associated with the PBX 102, can supply or gather trace information as required, and execute test scripts.

The diagnostics agents allow issues to be uniquely identified and correlated between different systems.

The support functionality 106 is not essential to the invention, and the advantages of the invention can be achieved by the provision of diagnostic agents in a PBX and the ITSP. However the invention is not limited to the provision of a diagnostics agent in a PBX or in an ITSP. The invention also encompasses the provision of a diagnostics agent in a SIP enabled telephone handset connected in a network. Communications to implement diagnostics may be between any element connected in the system having SIP functionality and provided with a diagnostics agent. For example this communication may be PBX to ITSP, PBX to PBX, ITSP to ITSP etc.

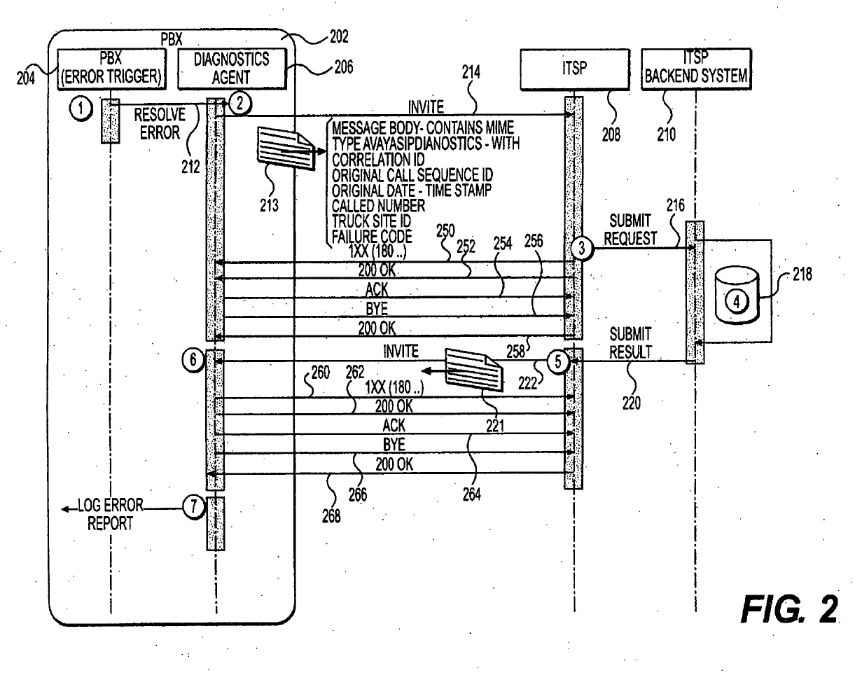

A more detailed example implementation is now described by way of reference to FIG. 2.

The diagnostics process can be initiated from either end (customer site or service provider). The core information exchange is the same in both scenarios, and there is always provision to enable the configuration to be exchanged out of band.

An embodiment is now described with reference to FIG. 2. For describing an embodiment, in FIG. 2 there is shown a PBX 202 having PBX functionality 204 and a diagnostics agent 206. An ITSP 208 includes an ITSP backend system 210.

In the example scenario it is assumed that a customer associated with the PBX 202 has attempted to dial an external call over an ITSP SIP trunk. The call was unsuccessful. Since this customer has been experiencing intermittent problems establishing calls, their system has been configured to trigger an investigation for this condition. FIG. 2 shows the sequence of the requests necessary to submit, and later receive, the results.

In a first step the PBX functionality 204 triggers a diagnostics probe request, due to a threshold error condition being met. In this example the threshold error condition is a failed call attempt. The diagnostic probe request comprises the PBX functionality 204 transmitting a ‘resolve error’ signal to the diagnostic agent 206 as denoted by signal line 212.

Responsive to the diagnostic probe request the diagnostics agent, in a second step, creates a DiagnoticsAgent request. This format uses XML and is structured to provide: the nature of the originator; local conditions that relate to the investigation; tests that the far end may invoke to gather information; directives related trace level; and preferred format.

This request from the diagnostics agent is packaged in the body of a SIP INVITE message as a MIME type application/avdiags. The message body 213 contains MIME type AVAYASIPDiagnostics, with correlation ID; Original call sequence ID; original date-time stamp; called number; trunk site ID; and failure code. Then the INVITE message is sent to the SIP URI that represents the ITSP remote end as denoted by signal 214.

After receipt of the SIP INVITE message there is an exchange of SIP signalling between the diagnostics agent 206 and the ITSP 208 as is commonly known in the art. This signalling is denoted by signals 250 to 258 in FIG. 2.

In a third step the DiagnosticsAgent request is extracted, at the ITSP, from the body of the INVITE message and sent with a submit request for processing by the backend systems of the ITSP as denoted by signal 216.

In a fourth step in the ITSP backend system(s) 218 the data is examined to: change logging levels; execute tests; obtain voice quality logs; and request detailed logs regarding a site or specific sessions. In this example the particular session dialog is of interest and the SIP session dialog that the call request failed on is used, a full SIP level trace is requested. The backend system retrieves the logs associated with this session, including the results of any down level logs that are available (this could be other service providers or internal systems). The result is then submitted from the backend system 218 to the ITSP 208 as denoted by signal 220.

In a fifth step the results are packaged by the ITSP 208 into a DiagnosticsAgent data block 221 in the body of a SIP INVITE message as a MIME type application/avdiags and an INVITE established back to the originator. This message is then transmitted to the diagnostics agent 206 as denoted by signal 222.

After receipt of the SIP INVITE message there is an exchange of SIP signalling between the diagnostics agent 206 and the ITSP 208 as is commonly known in the art. This signalling is denoted by signals 260 to 268 in FIG. 2.

In a sixth step on receipt of the error report at the diagnostics agent it is made available to the PBX system functionality 204 to supplement the logs, and can be persisted or sent on to support representatives in a seventh step as denoted by signal 270.

The data is preferably in XML format, using existing standards such as SOAP (simple object access protocol) or WS (web service) Security to provide security and integrity of the data. The data is preferably encapsulated in a SOAP Envelope.

The body of the SOAP packet contains the XML specific to the Diagnostics Agent when sent without encryption. If the data is encrypted then it is referenced by the ID attribute and stored in the encrypted data node of the security section. The preferred embodiments of the invention utilise existing SOAP and standards and security as defined by the WS-security standard.

The sections are:

Originator—provides details about the originating source site

Trace Directives—collection of trace enabling requests

Trace Directive—an discrete instance of a trace request

Test Directive—collection of test requests

Test Directive—a discrete instance of a test request

Trace Collection—collection of trace items

Trace Item—a discrete trace item, gather as a result of testing or historic logs

The table below describes the content of the data and how it is logically organised. This solution uses existing web services (WS) standards to encapsulate data. Closing tags are omitted for clarity. The purpose of Table 1 is to convey the configuration data that may be exchanged for SIP trunking configuration in accordance with embodiments of the invention.

<env:Envelope ...>
<env:Header>

| | |
|---|---|
| <wsse:Security...> | Provide digital signature and encryption info |
| | (if used) |
| <env:Body | Body of the Message, reference by |
| wsu:Id=”Body”> | encryption block, this would be stored in the |
| | EncryptedData node. |
| <avdiag:Originator | Information about the originator site |
| DiagnosticsAgentURI | SIP URI of the Originator Site |
| CustomerID | ID of the customer |
| CorrelationID | ID to reference in subsequent responses |
| ErrorCondition | Error Code |
| LocalTrace | Local trace information, - protocol level |
| | trace |
| SIPDialog | SIP Dialog of the session involved in the |
| | issue |
| TraceRequestDirectives | Collection of trace directives that enable |
| | tracing levels and concepts - Protocol, |
| | Voice Quality Stats |
| <avdiag:TraceDirective> | Instance of a trace directive - one per trace |
| | type |
| TraceType | Trace type, full protocol, voice quality, |
| | timeouts.. |
| TraceLifeTime | Trace active datetime UTC - determine how |
| | long the trace is to be live |
| TraceActiveIterations | Number of error conditions to capture before |
| | expiring trace directive |
| MaximumTraceDepth | Maximum number of sub nodes to utilise in |
| | dependency tracing |
| ErrorTriggerThreshold | Treat as error if condition count exceeded |
| <avdiag:TestDirectives> | Collection of Test Directives |
| <avdiag:TestDirective | Test Request Directive, reference to use in |
| ReferenceNo=”443”> | results |
| TypeTest | Type of test to validate, connectivity, |
| | session initiation, Voice Quailty, Bandwidth, |
| | Call Flow, Signalling. |
| TestExecutionTime | Time to begin test execution UTI |
| TestInterations | No of iterations of the test |
| TestDelay | Delay between iterations - secs |
| <avdiag:TraceCollection> | Collection of trace/test results |
| <avdiag:TraceItem | Trace Item |
| SourceReference = | |
| “” TestReference = “”> | |
| TestResult | Summary Condition of Test OK, |
| | Intermittent, Failed |
| TraceData | Trace data CDATA Section |
| RouteInfo | Routing history |
| BillingInfo | Billing information |

The invention thus takes advantage of the VoIP, preferably SIP infrastructure provided by the provision of Internet telephony services for PBXs to provide additional diagnostic services and functionality. The diagnostic functionality provided is flexible and dynamic. The functional elements such as the PBXs are provided with addressable diagnostic agents, preferably as applications running thereon. The diagnostic agents can be called and ‘talked to’, e.g. by e-mail, or can be addressed by a telephone extension. The diagnostic agents are preferably implemented as SIP User Agents.

In general embodiments of the invention provide a diagnostics technique for a SIP enabled telephony system, by providing an addressable diagnostics agent on at least one SIP enabled element in the system.

In a particularly preferred embodiments all SIP enabled elements of the telephony system are provided with addressable diagnostics agents. The diagnostic agents are able to collaborate across broader boundaries than normally handled by conventional diagnostics agents. The collaboration may also take place across diverse boundaries, from a PBX to an ITSP to potentially another ITSP and so on. These subsequent hops beyond the communication from the first diagnostics agent provide for powerful diagnostics.

The originator (i.e. the identity of the diagnostics agent originated the diagnostics operation) is also preferably provided, so that no matter how deep (i.e. how many hops) the request is processed, the final result can be returned to the originator. That provides, for example, PBX to ITSP to ITSP to PBX connections to give a true end-to-end scenario.

The invention provides a simple method to provide support activities, without adding additional infrastructure. The diagnostic agent can be initiated by either the support organisation or the customer. The mechanism requires no additional infrastructure. The agent enables diagnostics and support activities to maintain the site and potentially resolve problems.

The embodiment described herein is a simple example implementation of the invention. One skilled in the art will appreciate that the elements shown may form part of a much larger network. When a call is established from a PBX, it may transverse multiple network boundaries to reach its destination. The call may pass through, and be routed by, other telephony elements than a PBX or ITSP. As such there may be multiple ‘nodes’ at which diagnostics agents can be provided. Diagnostic agents are provided not only at endpoints, such as PBX 102 in FIG. 1, but throughout elements of the core network. In this way the diagnostics agents can be used to provide diagnostic information at various points throughout the path on which a call is established.

Endpoint diagnostics agents, such as provided at PBX 102, may enquire about active or failed calls to a core network diagnostics agent. Core network diagnostics agents may interact between themselves and interoperate in different networks. This advantageously allows the sending of diagnostic information end-to-end, regardless of the number of IP networks transversed.

An advantage of the deployment of diagnostics agents in this way is that they can convey convey billing information while the call is progressing.

The diagnostics agents also allow for information relating to the quality of voice and DTMF information to be conveyed, together with more specific information such as round-trip time.

Diagnostic agents also allow verbose information about call failure to be conveyed, together with recommendations of changes to SIP routing to be implemented, or any other network connectivity issues.

Advantageously diagnostic agents preferably allow this diagnostic information to be notified to telephones which have a display for the user to read.

Further an intelligent user agent may use the diagnostic information as described above to renegotiate codec, DTMF format or assess if additional media can be employed.

System administrators may use the diagnostic information to modify their SIP default proxy routes and tailor re-transmission timers to specific round-trip time, or to modify their dialling plan. They may also carry out checks on protocol conformance, signalling and media throughout the network. Congestion may be monitored with the ability to obtain additional routing information. Defective numbering or numbering problems may be identified, e.g. situations where subscriber does not exist. Where a number is defective, e.g. to a missing digit due to an incorrect dialling code being used, this may be identified and rectified.

The invention has been described herein by way of reference to particular embodiments. One skilled in the art will appreciated that the invention is not limited to the details of any such embodiments.

1. A method of providing diagnostic functionality in a SIP enabled telephony system comprising a plurality of SIP enabled functional elements each provided with a diagnostics agent, the method comprising the steps of: transmitting a SIP diagnostics request from an originator diagnostics agent of a first element to a diagnostics agent of a second element.

2. The method of claim 1 further comprising the step of transmitting the request from the second diagnostics agent to a third diagnostics agent.

3. The method of claim 1 further comprising the step of transmitting a diagnostics request to successive diagnostic agents.

4. The method of claim 1 wherein a diagnostics agent associated with a functional element forwards a diagnostic request to another diagnostics agent of another functional element on determination of that another functional element being associated with a session or attempted session with which the diagnostics request is concerned.

5. The method of claim 3 wherein a diagnostics agent associated with a functional element forwards a diagnostic request to another diagnostics agent of another functional element on determination of that another functional element being associated with a session or attempted session with which the diagnostics request is concerned.

6. The method of claim 1 wherein each diagnostics agent returns a reply to the diagnostics agent from which it received a request.

7. The method of claim 6 wherein a reply from each diagnostics agent receiving a diagnostics request is transmitted to the originating diagnostics agent.

8. The method of claim 6 wherein the SIP enabled functional elements include any one of: a private branch exchange, an Internet service telephony provider, or a telephone handset.

9. A SIP enabled telephony element including a diagnostics agent, and adapted to generate a diagnostics request for transmission to a diagnostics agent of a further SIP enabled telephony element.

10. The SIP enabled telephony system of claim 9 further adapted to generate the diagnostics request responsive to an error condition being met.

11. The SIP enabled telephony element of claim 10 wherein the error condition is a predetermined event at the SIP enabled telephony element.

12. The SIP enabled telephony element of claim 11 further adapted to generate the diagnostics request responsive to a diagnostics request being received from a further diagnostics agent.

13. The SIP enabled telephony element of claim 9 wherein a diagnostics agent of a functional element is adapted to determine a functional element associated with the diagnostic request, and transmit the diagnostic request to a diagnostics agent of that functional element.

14. The SIP enabled telephony element of claim 10 wherein a diagnostics agent of a functional element is adapted to determine a functional element associated with the diagnostic request, and transmit the diagnostic request to a diagnostics agent of that functional element.

15. The SIP enabled telephony element of claim 11 wherein a diagnostics agent of a functional element is adapted to determine a functional element associated with the diagnostic request, and transmit the diagnostic request to a diagnostics agent of that functional element.

16. The SIP enabled telephony element of claim 12 wherein a diagnostics agent of a functional element is adapted to determine a functional element associated with the diagnostic request, and transmit the diagnostic request to a diagnostics agent of that functional element.

17. The SIP enabled telephony element of claim 13 wherein the determination of the functional element associated with the diagnostic request includes identifying a functional element associated with a session.

18. The SIP enabled telephony element of claim 13 wherein the diagnostics request is intended to diagnose a feature of the session.
